(19) United States
(12) Patent Application Publication
(10) Pub. No.: US 2014/0095722 A1
(43) Pub. Date: Apr. 3, 2014

(54) CLOUD-BASED RESOURCE SHARING METHOD AND SYSTEM

(71) Applicant: TENCENT TECHNOLOGY (SHENZHEN) COMPANY LIMITED, Shenzhen (CN)

(72) Inventors: HAIJIAN LONG, Shenzhen (CN); KAI ZHANG, Shenzhen (CN); SHIQING FAN, Shenzhen (CN)

(73) Assignee: TENCENT TECHNOLOGY (SHENZHEN) COMPANY LIMITED, Shenzhen (CN)

(21) Appl. No.: 14/100,041

(22) Filed: Dec. 9, 2013

Related U.S. Application Data
(63) Continuation of application No. PCT/CN2013/081936, filed on Aug. 21, 2013.

(30) Foreign Application Priority Data
Aug. 31, 2012 (CN) 201210316966.7

(51) Int. Cl. H04L 12/911

(52) U.S. Cl. CPC H04L 47/70
USPC 709/226

(57) ABSTRACT

A cloud-based resource sharing method is included. The method includes a cloud storage server receiving a resource uploaded by a first user via a first terminal and storing the resource on the cloud storage server. The method also includes an online business obtaining access to the resource granted by the first user and accessing the cloud storage server. Further, the method includes the cloud storage server receiving an access request from the online business for accessing the resource and verifying whether the online business has access to the resource. When the cloud storage server determines that the online business has access, the cloud storage server allows the online business to access the resource.

### CROSS-REFERENCES TO RELATED APPLICATIONS

The application is a continuation of PCT Patent Application No. PCT/CN2013/081936, filed on Aug. 21, 2013, which claims priority of Chinese Patent Application No. 201210316966.7, filed on Aug. 31, 2012, the entire contents of which are hereby incorporated by reference.

### FIELD OF THE INVENTION

The present invention generally relates to Internet technologies and, more particularly, to methods and systems for sharing resources based on cloud storages.

### BACKGROUND

As mobile phone online capabilities and terminal processing capacity continue increasing, more and more people are familiar with using mobile terminal devices as mobile Internet access points.

However, currently, user resources are scattered over a variety of terminals or stored inside online businesses. Such user resource storage and maintenance approach has significant drawbacks: online businesses cannot share resources and are often isolated from each other and, thus, the user experience is cut off and is not smooth over using resources; terminal files are processed locally which consumes local resources; resource sharing is limited by networks and power supply, etc.; there often is no backup for user resources and the resources may be easily lost when the terminal is damaged; and there lacks professional management on resources, decreasing efficiency on input and output.

The disclosed methods and systems are directed to solve one or more problems set forth above and other problems.

### BRIEF SUMMARY OF THE DISCLOSURE

One aspect of the present disclosure includes a cloud-based resource sharing method. The method includes a cloud storage server receiving a resource uploaded by a first user via a first terminal and storing the resource on the cloud storage server. The method also includes an online business obtaining access to the resource granted by the first user and accessing the cloud storage server. Further, the method includes the cloud storage server receiving an access request from the online business for accessing the resource and verifying whether the online business has access to the resource. When the cloud storage server determines that the online business has access, the cloud storage server allows the online business to access the resource.

Another aspect of the present disclosure includes a cloud-based resource sharing method. The method includes a cloud storage server receiving a resource uploaded by a first user via a first terminal and storing the resource on the cloud storage server. The method also includes an online business obtaining access authorization granted by the first user for a second user, accessing the cloud storage server, and granting the second user with access authorization to the resource. The method also includes the cloud storage server receiving an access request from the second user for accessing the resource via a second terminal and verifying whether the second has access to the resource. When the cloud storage server determines that the second has access, the cloud storage server allows the second user to access the resource.

Another aspect of the present disclosure includes a cloud-based resource sharing system. The system includes a storage module, an obtaining module, a receiving module, and a verification module. The storage module is configured for a cloud storage server to receive a resource uploaded by a first user via a first terminal and to store the resource on the cloud storage server. The obtaining module is configured for an online business to obtain access to the resource granted by the first user and to access the cloud storage server. Further, the receiving module is configured for the cloud storage server to receive an access request from the online business for accessing the resource. The verification module is configured for the cloud storage server to verify whether the online business has access to the resource, wherein, when the verification module determines that the online business has access, the verification module allows the online business to access the resource.

Another aspect of the present disclosure includes a cloud-based resource sharing system. The system includes a storage module, an obtaining module, a receiving module, and a verification module. The storage module is configured for a cloud storage server to receive a resource uploaded by a first user via a first terminal and to store the resource on the cloud storage server. The obtaining module is configured for an online business to obtain access authorization granted by the first user for a second user, to access the cloud storage server, and to grant the second user with access authorization to the resource. The receiving module is configured for the cloud storage server to receive an access request from the second user for accessing the resource via a second terminal. Further, the verification module is configured for the cloud storage server to verify whether the second has access to the resource. When the verification module verifies that the second has access, the verification module allows the second user to access the resource.

Other aspects of the present disclosure can be understood by those skilled in the art in light of the description, the claims, and the drawings of the present disclosure.

### BRIEF DESCRIPTION OF THE DRAWINGS

FIG. 1 illustrates a flowchart of an exemplary resource sharing process consistent with the disclosed embodiments;

FIG. 2 illustrates a flowchart of another exemplary resource sharing process consistent with the disclosed embodiments;

FIG. 3 illustrates an exemplary resource sharing system consistent with the disclosed embodiments;

FIG. 4 illustrates another exemplary resource sharing system consistent with the disclosed embodiments;

FIG. 5 illustrates an operating environment incorporating certain aspects of the disclosed embodiments; and

FIG. 6 illustrates a block diagram of an exemplary computer system consistent with the disclosed embodiments.

### DETAILED DESCRIPTION

Reference will now be made in detail to exemplary embodiments of the invention, which are illustrated in the accompanying drawings.

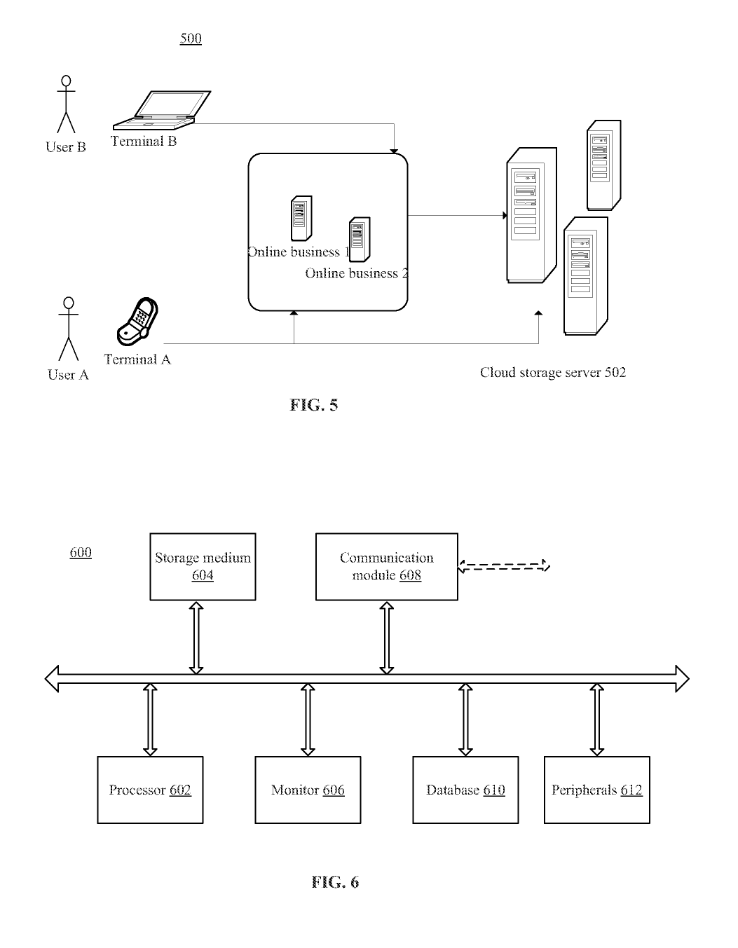

FIG. 5 illustrates an exemplary operating environment 500 incorporating certain disclosed embodiments. As shown in FIG. 5, environment 500 may include a user A, a terminal A, a cloud storage server 502, an online business 1, an online business 2, a terminal B, and a user B. The number of users, terminals, online businesses, and servers are used for illustrative purposes only, any number of devices may be used and other devices may also be included. Further, the various devices may be coupled together using computer networks, such as the Internet.

A terminal, as used herein, may refer to any appropriate user terminal with certain computing capabilities, such as a smart phone, a personal computer (PC), a work station computer, a hand-held computing device (tablet), a mobile phone, or any other user-side computing device. A terminal may run certain client software programs to implement certain functionalities, such as social networking client-side functions, short message client-side functions, etc.

A cloud storage server, as used herein, may refer to one or more server computers configured to provide certain cloud server functionalities, such as cloud-based storage, database management, and/or search engines. A cloud storage server may also include one or more processors to execute computer programs in parallel.

Online business 1 and online business 2 may include any hardware and/or software for providing online services to users. Further, user A and user B may use corresponding terminals to access the cloud storage server and/or online businesses.

The terminal (e.g., terminal A, terminal B), the cloud storage server 502, and/or the online business may be implemented on any appropriate computing platform. FIG. 6 shows a block diagram of an exemplary computer system 600 capable of implementing the terminal, the cloud storage server 502, and/or the online business.

As shown in FIG. 6, computer system 600 may include a processor 602, a storage medium 604, a monitor 606, a communication module 608, a database 610, and peripherals 612. Certain devices may be omitted and other devices may be included.

Processor 602 may include any appropriate processor or processors. Further, processor 602 can include multiple cores for multi-thread or parallel processing. Storage medium 604 may include memory modules, such as ROM, RAM, flash memory modules, and erasable and rewritable memory, and mass storages, such as CD-ROM, U-disk, and hard disk, etc. Storage medium 604 may store computer programs for implementing various processes, when executed by processor 602.

Further, peripherals 612 may include I/O devices such as keyboard and mouse, and communication module 608 may include network devices for establishing connections through the communication network. Database 610 may include one or more databases for storing certain data and for performing certain operations on the stored data, such as database searching.

Returning to FIG. 5, in operation, the users may store resources in the cloud storage server, which then facilitates other users and other online businesses to access the resource stored on the cloud storage server such that the stored resources can be shared. Specifically, the terminal, the cloud storage serve, and/or the online business may perform certain methods to achieve resource sharing. FIG. 1 illustrates an exemplary cloud storage resource sharing process consistent with the disclosed embodiments.

As shown in FIG. 1, the resource sharing process includes the following steps:

S11: receiving a resource uploaded by a first user (e.g., user A) and storing the resource in a cloud storage server. Cloud storage is a network service with resource storage and management capabilities. The cloud storage provides with external entities with standard HTTP (HyperText Transfer Protocol) or HTTPS protocol interfaces, including authentication, authorization, and resource operation, etc. In general, the cloud storage is maintained by a dedicated company and is implemented based on a large number of servers (together as the cloud storage server).

The first user may be an individual user. The first user may use a terminal (i.e., any terminal equipment capable of accessing the Internet, including wireless terminals and PCs, such as terminal A) to upload resources. Resources, as used herein, may include any type of online resources, which can be physical resources or non-physical resources.

Physical resources mainly refer to the documents, pictures, music, video, and other file resources, while non-physical resources mainly refer to the user information, game levels, the relationship chain of friends, and other resources. In certain embodiments, these resources are stored in the cloud storage server, rather than stored locally or stored in online businesses. A user can first set up online resources through the user's own terminal equipment and then access various online services. Because the online resources are stored in the cloud storage servers, which provide cloud storage interfaces based on standard HTTP protocol, the user can easily, quickly and safely store his own resources as the HTTP protocol is an open protocol without any threshold limitations.

For example, when the first user decides to upload a resource, e.g., a movie resource M1, the user does not store the movie resource M1 on the terminal used by the first user to upload the movie resource M1 or store in any online video services, such as Tencent Video (an online video service). Instead, the resource uploaded by the first user is directly stored in the cloud storage server so that other users, especially those users who do not use or were not registered to use the online video services, e.g., non-Tencent Video users, can access the movie resource M1.

If the movie resource M1 is stored in the online business, a non-user of the online business may be unable to access the movie resource M1. Thus, by storing the resource uploaded by the first user in the cloud storage server, more users are allowed to access the resource.

S12: an online business obtains access to the resource granted by the first user, and the online service accesses the cloud storage server.

For example, the first user may grant authorization to the online business (i.e., an online application providing with users with a certain service, such as social networking, instant messaging, and other online service) for accessing the resource, such as the movie resource M1. The authorization is an online business authorization issued by the first user. Of course, the online business is not limited to online video playback software application, such as Tencent Video software or other companies' video playback software applications. For example, the online business may also include photo sharing, movie recommendation, third-party data analysis, and online data processing, so as to carry out certain processing of the movie resource M1. That is, if the resource is a movie resource, the first user allows any online business to access the resource, not limited to video playback software, such that different users can use the resource in different aspects of the resource.

S13: the cloud storage server receives an access request from the online business for accessing the resource.

After the online business obtains authorization to access the resource, a second user, i.e., a user of the online business, can access the resource by accessing the online business. The second user, as used herein, may refer to any type of user of the online business, so long as to be able to access the online business. For example, the second user may be a non-registered user, a registered user, an ordinary user, or advanced users.

S14: the cloud storage server verifies whether the online business has access to the resource. If the cloud storage server determines that the online business has authorization, the cloud server allows the online business to access the resource.

That is, after the cloud storage server receives the access request, the cloud storage server determines whether the online business indeed has authorization for access. If the cloud storage server determines that the online business has online business authorization for access, the cloud storage server allows the access. On the other hand, if the cloud storage server determines that the online business does not have authorization for access, the cloud storage server denies the access.

Thus, using this resource sharing approach, users can upload their own resources to the cloud storage server, such that online businesses can access the resources stored in the cloud storage server after being granted access to the resource. On the one hand, because cloud storage interfaces are based on standard HTTP protocol, which is open access and has no threshold limit, users can easily, quickly and safely store their own resources. On the other hand, because each individual online business has its own business rules and its ability to access the cloud storage, the resource creators, i.e., the users, and any authorized online business can access the online resources, providing a better social experience and resources. Further, resources being accessed are not limited by a particular online business, so that it is possible to save resources and the resources provided by the users via the cloud storage server can be effectively managed.

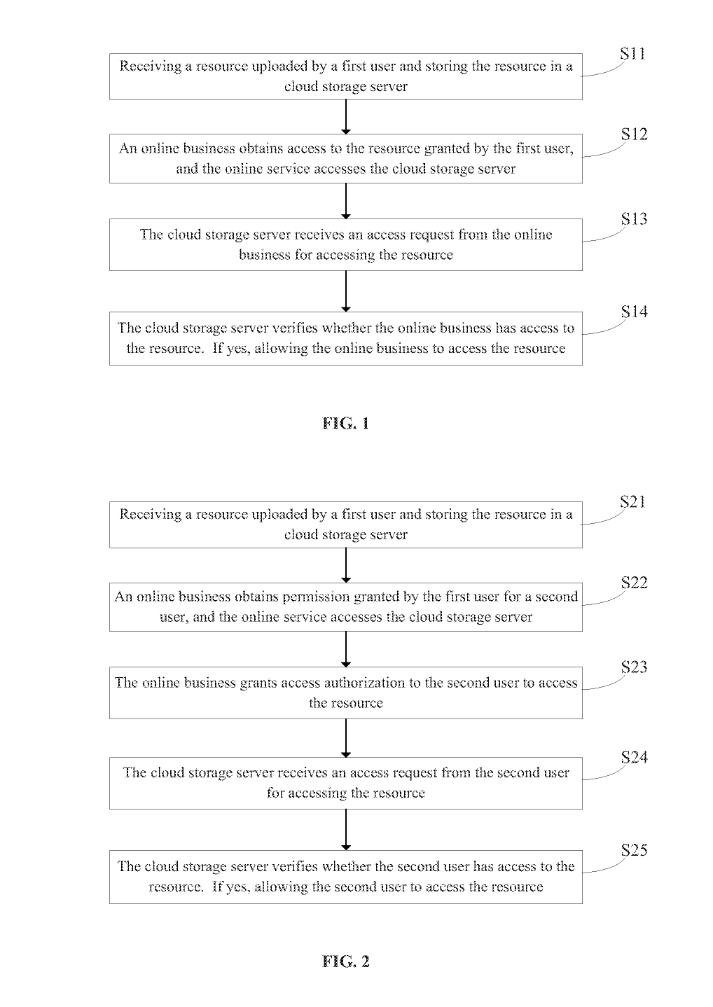

FIG. 2 illustrates another exemplary cloud storage resource sharing process consistent with the disclosed embodiments. As shown in FIG. 2, the resource sharing process includes the following steps:

S21: receiving a resource uploaded by a first user (e.g., user A) storing the resource in a cloud storage server.

S22: an online business obtains permission granted by the first user for a second user, and the online service accesses the cloud storage server.

That is, the online business has not obtained access authorization from the first user for the online business to access the resource on the cloud storage server. Instead, the online business obtains access authorization granted by the first user for the second user to access the resource on the cloud storage server. For example, when the second user uses an online business not used by the first user, i.e., the first user and the second user do not use the same online business, direct authorization from the first user to the online business used by the second user may be difficult. Or, even the first user and the second user are using the same online business, but the first user cannot grant access to the online business directly, and instead the first user grants the online business the access permission for the second user. In other words, the first user does not grant the online authorization to the online business and, instead, grant a user authorization for the second user to the online business.

Because the resource to be accessed is stored in the cloud storage server, the online business needs to specify relevant information of the resource. Thus, the online business needs to access the cloud storage server.

S23: the online business grants access authorization to the second user to access the resource. Because the first user grants the user authorization for the second user to the online business, the online business in turn grants the second user the authorization to access the resource.

It should be noted that, the first user may be a user of the online business or may be a non-user of the online business. For example, the first user may be a Tencent Video user, while the second user is a user of a certain dating site and does not use the Tencent Video. When the first user wants to allow the second user to access the resource, the first user grants access permission to the dating site, and the dating site in turn grants the access permission to the second user, such that the second user can visit the resource. That is, even though the first user is not a user of the dating site, the first user can still use the dating site to grant the second user permission to access the resource. The second user may be a user with access privilege specified by the first user or may be a user the online business decides to authorize access.

S24: the cloud storage server receives an access request from the second user for accessing the resource.

S25: the cloud storage server verifies whether the second user has access to the resource. If the cloud storage server determines that the second user has authorization, the cloud server allows the second user to access the resource.

It should be noted that, both the first user and the second user can access the cloud storage server. For example, the first user and the second user can use a browser or any client-side software program to access the cloud storage server. Thus, the second user is not limited to accessing the cloud storage server only through the online businesses, as long as the second user can access the cloud storage server with the access authorization.

This resource sharing process may also be illustrated by the following user scenario. The first user stores a movie M1 on the cloud storage server; the first user has a friend, the second user, in an online business 1; and the first user wants to share the movie M1 with the second user. The first user grants the access permission to the online business 1, and the online business in turn grants the access permission to the second user for accessing the movie M1. Further, the second user, with the access permission for accessing the movie M1, accesses the cloud storage server to visit the movie M1. The cloud storage server verifies the access permission of the second user, and determines that the second user has the access permission. The second user visits the movie M1 to watch movie M1.

FIG. 3 illustrates an exemplary cloud-based resource sharing system 30 consistent with the disclosed embodiments. As shown in FIG. 3, the resource sharing system 30 includes a storage module 31, an obtaining module 32, a receiving module 33, a verification module 34, and an access module 35.

The storage module 31 is configured to receive a resource uploaded by a first user and to store the resource on the cloud storage server. The obtaining module 32 is configured for an online business to obtain access to the resource granted by the first user, and the online service accesses the cloud storage server. Further, the receiving module 33 is configured for the cloud storage server to receive an access request from the online business for accessing the resource. The verification module 34 is configured for the cloud storage server to verify whether the online business has access to the resource. If the verification module 34 verifies that the online business has authorization, the cloud server allows the online business to access the resource. In addition, the access module 35 is configured for the second user to access the resource through the online service.

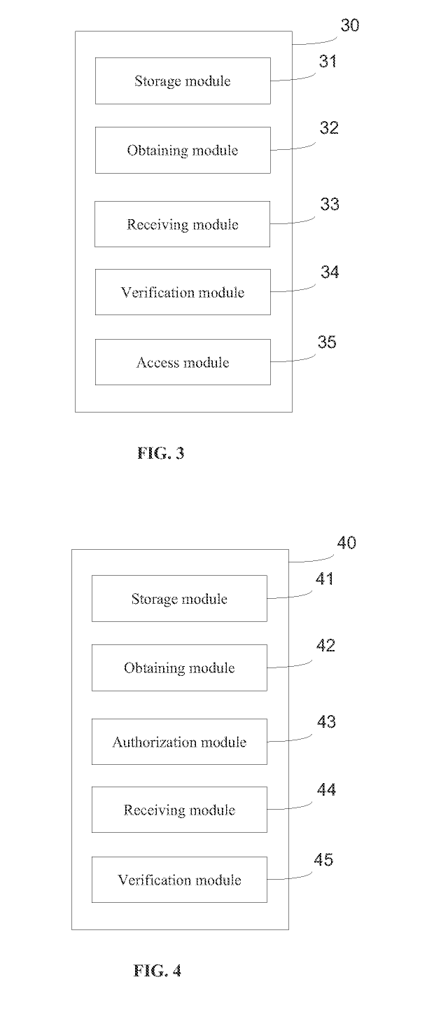

FIG. 4 illustrates another exemplary cloud-based resource sharing system 40 consistent with the disclosed embodiments. As shown in FIG. 4, the resource sharing system 40 includes a storage module 41, an obtaining module 42, an authorization module 43, a receiving module 44, and a verification module 45.

The storage module 41 is configured to receive a resource uploaded by a first user and to store the resource on the cloud storage server. The obtaining module 42 is configured for an online business to obtain permission granted by the first user for a second user, and the online service accesses the cloud storage server. Further, the authorization module 43 is configured for the online business to grant access authorization to the second user to access the resource. The receiving module 44 is configured for the cloud storage server to receive an access request from the second user for accessing the resource. Further, the verification module 45 is configured for the cloud storage server to verify whether the second user has access to the resource. If the verification module 45 verifies that the second user has authorization, the cloud server allows the second user to access the resource. The second user may be specified by the first user, and both the first user and the second user may access the cloud storage server via corresponding terminals.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art.

The disclosed methods and systems can be used in a variety of internet resource sharing and management applications. By using the disclosed methods and systems, users can upload their own resources to the cloud storage server, such that online businesses can access the resources stored in the cloud storage server after being granted access to the resource. On the one hand, because cloud storage interfaces are based on standard HTTP protocol, which is open access and has no threshold limit, users can easily, quickly and safely store their own resources. On the other hand, because each individual online business has its own business rules and its ability to access the cloud storage, the resource creators, i.e., the users, and any authorized online business can access the online resources, providing a better social experience and resources.

Further, resources being accessed are not limited by a particular online business, so that it is possible to save resources and the resources provided by the users via the cloud storage server can be effectively managed.

What is claimed is:

1. A cloud-based resource sharing method, comprising:
receiving, by a cloud storage server, a resource uploaded by a first user via a first terminal;
storing, by the cloud storage server, the resource on the cloud storage server;
obtaining, by an online business, access to the resource granted by the first user;
accessing, by the online business, the cloud storage server;
receiving, by the cloud storage server, an access request from the online business for accessing the resource;
verifying, by the cloud storage server, whether the online business has access to the resource, wherein, when the cloud storage server determines that the online business has access, the cloud storage server allows the online business to access the resource.

2. The method according to claim 1, further including:
a second user access the resource via the online business

3. The method according to claim 1, wherein accessing the cloud storage server further includes:
accessing the cloud storage server by a storage interface based on hypertext transfer protocol (HTTP).

4. A cloud-based resource sharing method, comprising:
receiving, by a cloud storage server, a resource uploaded by a first user via a first terminal;
storing, by the cloud storage server, the resource on the cloud storage server;
obtaining, by an online business, access authorization granted by the first user for a second user;
accessing, by the online business, the cloud storage server;
granting, by the online business, the second user with access authorization to the resource;
receiving, by the cloud storage server, an access request from the second user for accessing the resource via a second terminal;
verifying, by the cloud storage server, whether the second has access to the resource, wherein, when the cloud storage server determines that the second has access, the cloud storage server allows the second user to access the resource.

5. The method according to claim 4, wherein:
the second user is specified by the first user.

6. The method according to claim 4, wherein:
the second user is a user of the online business; and
the first user is not a user of the online business.

7. The method according to claim 4, wherein:
the first user does not grant access to the online business itself, and only grants access to the second user via the online business.

8. A cloud-based resource sharing system, comprising:
a storage module configured for a cloud storage server to receive a resource uploaded by a first user via a first terminal and to store the resource on the cloud storage server;
an obtaining module configured for an online business to obtain access to the resource granted by the first user and to access the cloud storage server;
a receiving module configured for the cloud storage server to receive an access request from the online business for accessing the resource; and
a verification module configured for the cloud storage server to verify whether the online business has access to the resource, wherein, when the verification module determines that the online business has access, the verification module allows the online business to access the resource.

9. The system according to claim 8, further including:
an access module configured for the second user to access the resource via the online business.

10. A cloud-based resource sharing system, comprising:
a storage module configured for a cloud storage server to receive a resource uploaded by a first user via a first terminal and to store the resource on the cloud storage server;
an obtaining module configured for an online business to obtain access authorization granted by the first user for a second user, to access the cloud storage server, and to grant the second user with access authorization to the resource;
a receiving module configured for the cloud storage server to receive an access request from the second user for accessing the resource via a second terminal;
a verification module configured for the cloud storage server to verify whether the second has access to the resource, wherein, when the verification module verifies that the second has access, the verification module allows the second user to access the resource.

11. The system according to claim 10, wherein:
the second user is specified by the first user.

12. The system according to claim 10, wherein:
the second user is a user of the online business; and
the first user is not a user of the online business.

13. The system according to claim 10, wherein:
the first user does not grant access to the online business itself, and only grants access to the second user via the online business.
